(19) United States
(12) Patent Application Publication
(10) Pub. No.: US 2010/0034617 A1
(43) Pub. Date: Feb. 11, 2010

(54) LOCKING DEVICE

(75) Inventor: Ming-Yi Liao, Taoyuan County (TW)

Correspondence Address: RABIN & Berdo, PC, 1101 14TH STREET, NW, SUITE 500, WASHINGTON, DC, 20005, US

(73) Assignee: Power Network Industry Co., Ltd., Taoyuan County (TW)

(21) Appl. No.: 12/535,940

(22) Filed: Aug. 5, 2009

(30) Foreign Application Priority Data
Aug. 7, 2008 (TW) 097214168

(51) Int. Cl. F16B 37/08

(52) U.S. Cl. 411/432; 192/45

(57) ABSTRACT

A locking device includes an outer ring and a locking disk is located on a first side of the outer ring and has a shaft which extends through the outer ring. An annular ring, a needle roller bearing, a first washer, a second washer, and a transmission disk are mounted to the shaft, respectively. The first washer is co-rotated with the shaft and the second washer is co-rotated with the outer ring. The transmission disk is freely mounted to the shaft by a clamp and includes first recesses and second recesses which are shallower than the first recesses. Balls are located between the first and second washers and movably engaged with the first recesses or the second recesses so as to control the movement of the transmission disk to be engaged with a rotatable part such as a grinding wheel of a sand wheel machine.

### BACKGROUND OF THE INVENTION

1. Field of the Invention

The present invention relates generally to a locking device for a rotatable part, which can output a high torque and be conveniently and power-savingly operated.

2. The Prior Arts

A conventional way to lock a rotatable part of a machine such as a grinding wheel of a sand wheel machine is to use bolts cooperated with nuts. However, the fixing or loosening of the bolts and nuts has to use a suitable tool such as a wrench or a screw driver. The user has to prepare the tool at hand; thereby it is inconvenient to tight or loosen the bolts and nuts.

Taiwanese Patent No. M333481 discloses a locking device, which does not need to use any hand tool in operation and improves the disadvantage of the conventional locking method mentioned above. Nevertheless, the locking device can be easily loosened by an external impact applied on a direction that makes the locking device be loosened.

### SUMMARY OF THE INVENTION

A primary objective of the present invention is to provide a locking device for a rotatable part and the locking device improves the shortcoming of the conventional locking device.

The operational concept of the locking device of the present invention is similar to a planet gear system. The locking device includes an outer ring, a locking disk, an annular ring, a needle roller bearing, a first washer, a second washer, and a transmission disk mounted to the shaft on the locking disk. The outer ring performs as the outermost gear of the planet gear system, the balls perform as the planet gears, and the locking disk performs as the sun gear. When the outer ring is rotated in the first direction, the second washer is co-rotated with the outer ring and the balls are moved by the second washer, the first washer is rotated by the balls, which drive the locking disk to rotate. The balls are moved from first recesses in the transmission disk to second recesses so as to push the transmission disk outward axially to be connected with a rotatable part.

When the outer ring is rotated in the second direction, the second washer is co-rotated with the outer ring and the springs are compressed until the balls are moved from the second recesses to the first recesses so that the transmission disk is no longer pushed by the balls and can be disengaged from the rotatable part. Then, the recover force of the springs forces the first washer, the transmission disk, and the locking disk to rotate clockwise to move the balls back to the second recesses.

When an external impact applies to the locking device which is in the locked state, the springs absorb the impact. When the springs release the impact, the second washer is moved back to its original position and the balls are still received in the shallow second recesses such that the rotatable part is not loosened.

The present invention is to provide a locking device which comprises an outer ring. A locking disk and a transmission disk are located on two sides of the outer ring, respectively. The locking disk includes a shaft which extends through the outer ring. An annular ring and a needle roller bearing are mounted to the shaft, respectively. A first washer is mounted to the shaft and co-rotated with the shaft, and has a plurality of first radial parts extending radially therefrom. Each of the first radial parts has a first protrusion extending from a side thereof A second washer is mounted to the shaft and has a plurality of second radial parts extending radially therefrom. Each of the second radial parts has a second protrusion extending from a side thereof. The second washer is connected to the outer ring and co-rotated with the outer ring. The transmission disk is mounted to a distal end of the shaft which is freely rotated relative to the transmission disk. The transmission disk has multiple first recesses and multiple second recesses which are shallower than the first recesses. A plurality of balls are located between the first radial parts and the second radial parts, the balls are movably engaged with the first recesses or the second recesses. The transmission disk is pushed axially away from the outer ring when the balls are engaged with the second recesses. A plurality of springs are biased between the first protrusions and the second protrusions.

The shaft includes a threaded hole defined centrally therein so as to be connected with a threaded rod on a machine.

Two O-rings are respectively located between the inner periphery of the outer ring and the outer periphery of the transmission disk, and between the inner periphery of the outer ring and the outer periphery of the locking disk so as to provide a suitable friction between those parts.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a locking device according to the present invention and a threaded rod on a machine;

FIG. 2 is an exploded view showing the locking device of the present invention;

FIG. 3 is a cross sectional view showing the locking device of the present invention;

FIG. 3A is a cross sectional view showing that a transmission disk is pushed by balls and engaged with a rotatable part;

FIG. 4 shows that an outer ring of the locking device is rotated counter clockwise to a locked state;

FIG. 4A shows that the balls are located in shallower second recesses in the transmission disk of the locking device;

FIG. 5 shows that the outer ring of the locking device is rotated clockwise to an unlocked state;

FIG. 5A shows that the balls are located in deeper first recesses in the transmission disk of the locking device;

FIG. 6 shows that an external impact is applied to the outer ring which is rotated clockwise and the springs are compressed, and then the recover force of the springs move the locking device back to the locked state; and

FIG. 6A shows that the balls are moved back to the shallower second recesses by the springs.

### DETAILED DESCRIPTION OF THE PREFERRED EMBODIMENT

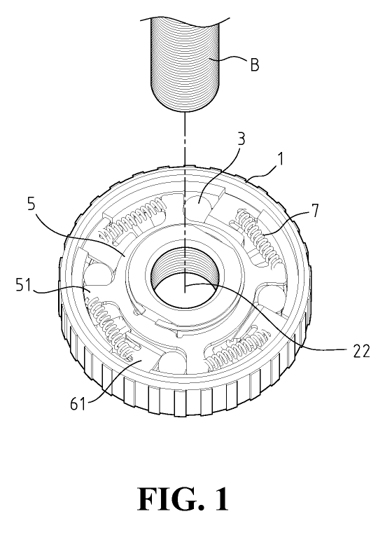

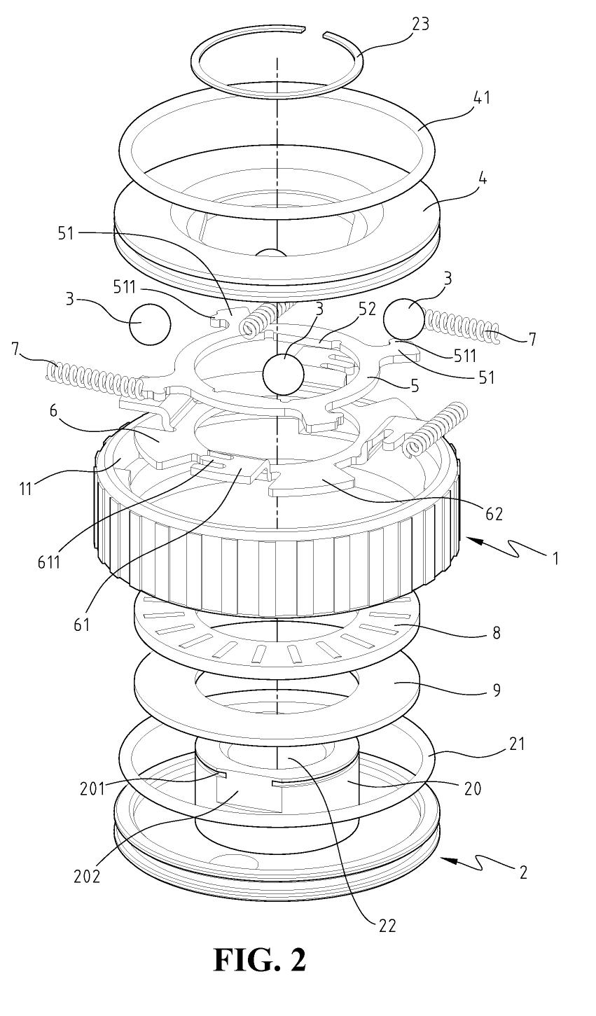

With reference to the drawings and in particular to FIGS. 1-3, a locking device in accordance with the present invention comprises an outer ring 1 having an internal space defined therein and a plurality of ribs extending from an outer surface thereof so as to provide a proper friction when the user holds the outer ring 1 and rotates it. A locking disk 2 is located on the first side of the outer ring 1 and has a shaft 20 extending from a center thereof. The shaft 20 extends through the outer ring 1 and an annular ring 9 and a needle roller bearing 8 are mounted to the shaft 20 respectively. A first washer 5, a second washer 6, a transmission disk 4 are respectively mounted to the shaft 20 and located on the second side of the outer ring 1. The locking disk 2, the annular ring 9, the needle roller bearing 8, the second washer 6, the first washer 5, and the transmission disk 4 are received in the internal space of the outer ring 1. An O-ring 41 is located between an inner periphery of the outer ring 1 and an outer periphery of the transmission disk 4, and another O-ring 21 is located between the inner periphery of the outer ring 1 and an outer periphery of the locking disk 2. The two O-rings 41, 21 provide a proper friction between the outer ring 1 and the transmission disk 4 and the locking disk 2, respectively. A flange extends inward from the inner periphery of the outer ring 1 so as to define two stepped surfaces in the first and second sides thereof. The locking disk 2 and the transmission disk 4 are respectively engaged with the two stepped surfaces. The outer ring 1 includes multiple notches 11 defined in the flange at the inner periphery of the outer ring 1.

The first washer 5 has a central hole and two first flat surfaces 52 are defined in an inner periphery of the central hole. The shaft 20 of the locking disk 2 includes two second flat surfaces 202 which are engaged with the first flat surfaces 52 such that the first washer 5 is co-rotated with the shaft 20. The first washer 5 further has a plurality of first radial parts 51 extending radially therefrom and each first radial part 51 has a first protrusion 511 extending from a side thereof.

The second washer 6 has a plurality of second radial parts 61 extending radially therefrom and each second radial part 61 has a second protrusion 611 extending from a side thereof. The second washer 6 further includes engaging plates 62 extending radially therefrom and the engaging plates 62 are engaged with the notches 11 so that the second washer 6 is co-rotated with the outer ring 1.

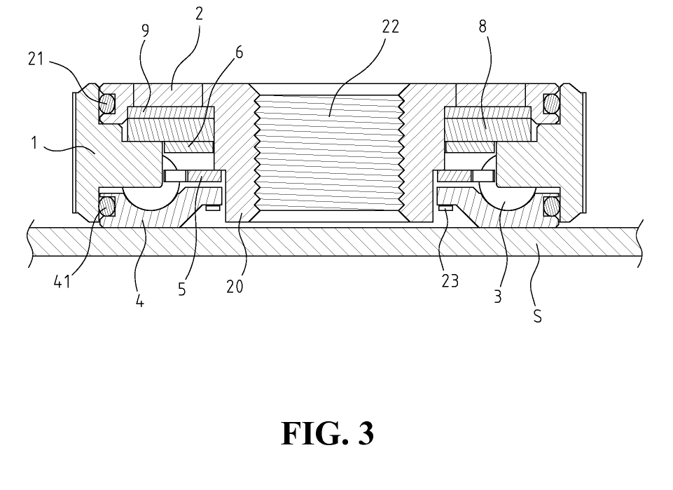

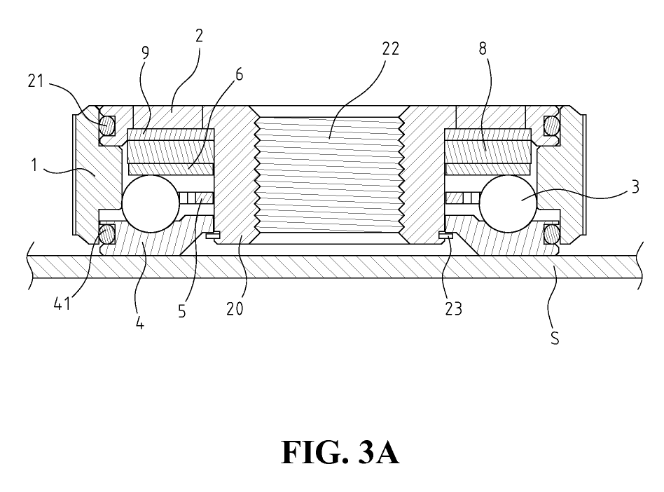

The transmission disk 4 is mounted to a distal end of the shaft 20 which has a snap groove 201 defined in an outer surface thereof and a clamp 23 is engaged with the snap groove 201 such that the shaft 20 is freely rotatable relative to the transmission disk 4. The transmission disk 4 has multiple first recesses 42 and multiple second recesses 43 which are shallower than the first recesses 42. The first and second recesses 42, 43 are located at the first side thereof which faces the first and second washers 5, 6. The second side of the transmission disk 4 is the engaging side which is to be engaged with a rotatable part “S” such as a grinding wheel of a sand wheel machine as shown in FIG. 3.

A plurality of balls 3 are located between the first radial parts 51 and the second radial parts 61, the balls 31 are movably engaged with the first recesses 42 or the second recesses 43.

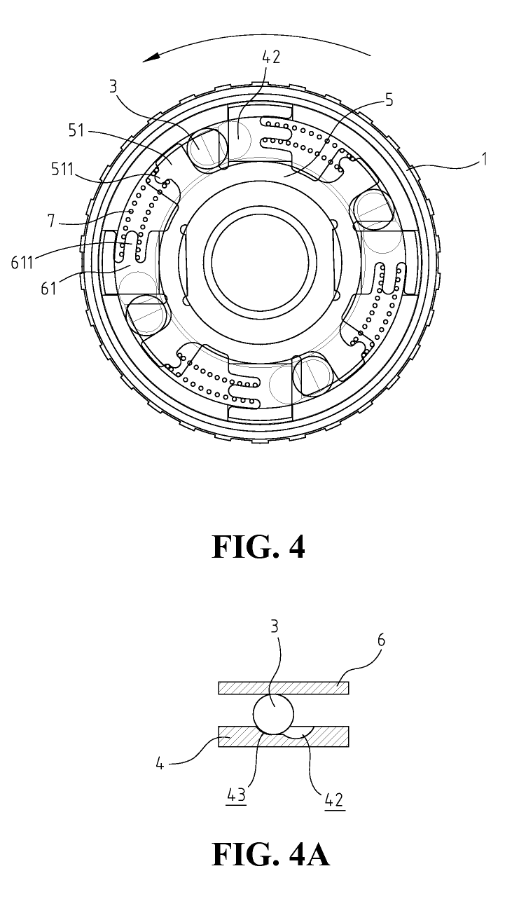

A plurality of springs 7 are located in the internal space of the outer ring 1 and biased between the first and second protrusions 511, 611 as shown in FIG. 4.

After the locking device is assembled, the shaft 20 can be connected to a threaded rod “B” on a machine as shown in FIG. 1 by a threaded hole 22 defined centrally in the shaft 20. The locking device is similar to a planet gear system, wherein the outer ring 1 performs as the outermost gear of the planet gear system, the balls 3 performs as the planet gears, and the locking disk 2 performs as the sun gear.

When the outer ring 1 is rotated in the first direction (counter clockwise) as shown in FIG. 4, the second washer 6 is co-rotated with the outer ring 1 and the balls 3 are moved by the second radial parts 61 of the second washer 6. The first washer 5 is rotated by the balls 3, which drive the locking disk 2 to rotate. The balls 3 are moved from the first recesses 42 in the transmission disk 4 to the second recesses 43 as shown in FIGS. 3A and 4A so as to push the transmission disk 4 outward axially to be engaged with the rotatable part “S”.

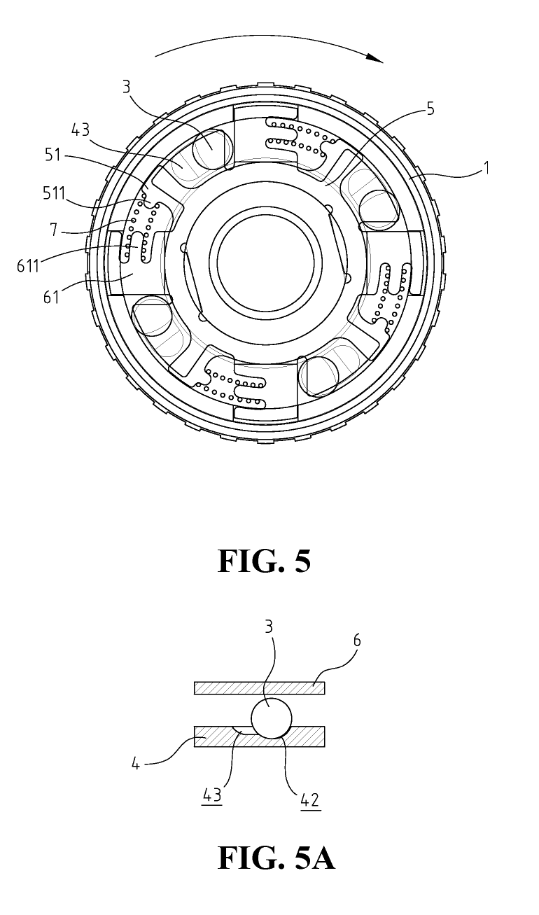

As shown in FIGS. 5 and 5A, when the outer ring 1 is rotated in the second direction (clockwise), the second washer 6 is co-rotated with the outer ring 1 and the springs 7 are compressed until the balls 3 are moved from the second recesses 43 to the first recesses 42 so that the transmission disk 4 is no longer pushed by the balls 3 and can be disengaged from the rotatable part “S”. Then, the recover force of the springs 7 forces the first washer 5, the transmission disk 4, and the locking disk 2 to rotate clockwise to move the balls 3 back to the second recesses 43.

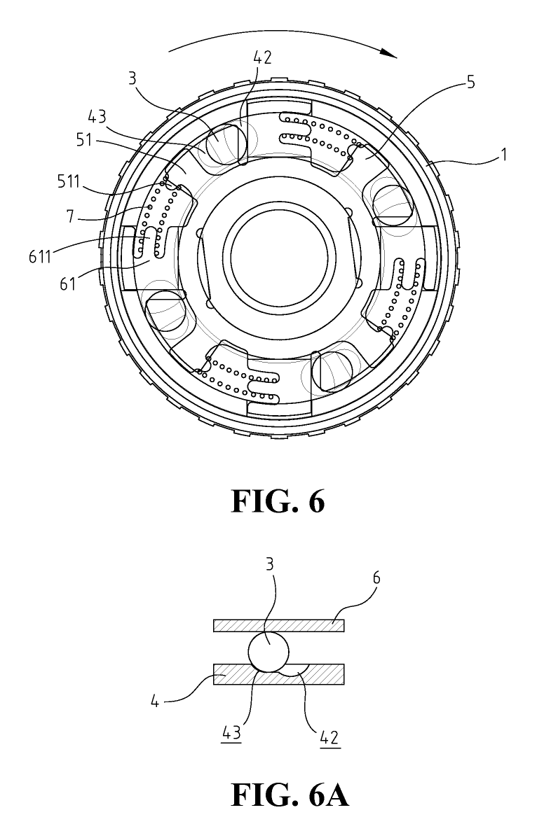

As shown in FIGS. 6 and 6A, when an external impact applies to the locking device which is in the locked state, the outer ring 1 and the second washer 6 rotate toward the second direction (clockwise), the balls 3 moves, the first washer 5 and the locking disk 2 are stationary, and the springs 7 are compressed to absorb the impact. When the springs 7 releases the impact, the outer ring 1 and the second washer 6 are moved back to their original positions and the balls 3 are still received in the shallow second recesses 43 such that the rotatable part “S” is not loosened.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A locking device, comprising
an outer ring having an internal space defined therein;
a locking disk located on a first side of the outer ring and having a shaft extending from a center thereof, the shaft extending through the outer ring;
an annular ring and a needle roller bearing mounted to the shaft, respectively;
a first washer mounted to the shaft and co-rotated with the shaft, the first washer having a plurality of first radial parts extending radially therefrom and each of the first radial parts having a first protrusion extending from a side thereof;
a second washer mounted to the shaft and having a plurality of second radial parts extending radially therefrom, each of the second radial parts having a second protrusion extending from a side thereof, the second washer connected to the outer ring and co-rotated with the outer ring;
a transmission disk mounted to a distal end of the shaft, which is freely rotated relative to the transmission disk, the transmission disk having multiple first recesses and second recesses that are shallower than the first recesses;
a plurality of balls located between the first radial parts and the second radial parts, the balls movably engaged with the first recesses or the second recesses, the transmission disk being pushed axially away from the outer ring when the balls are engaged with the second recesses, and
a plurality of springs biased between the first protrusions and the second protrusions.

2. The locking device as claimed in claim 1, wherein the first washer has a central hole and two first flat surfaces are defined in an inner periphery of the central hole, the shaft of the locking disk includes two second flat surfaces which are engaged with the first flat surfaces such that the first washer is co-rotated with the shaft.

3. The locking device as claimed in claim 1, wherein the outer ring includes multiple notches defined in an inner periphery thereof and the second washer includes engaging plates extending radially therefrom, the engaging plates are engaged with the notches, respectively so that the second washer is co-rotated with the outer ring.

4. The locking device as claimed in claim 1, wherein an O-ring is located between an inner periphery of the outer ring and an outer periphery of the transmission disk.

5. The locking device as claimed in claim 1, wherein an O-ring is located between an inner periphery of the outer ring and an outer periphery of the locking disk.
